(19) United States
(12) Patent Application Publication
(10) Pub. No.: US 2007/0002271 A1
(43) Pub. Date: Jan. 4, 2007

(54) Glass frames

(76) Inventor: Pietro Rancan, TRISSINO (IT)

Correspondence Address: LEFFERT JAY & POLGLAZE, P.A., P.O. BOX 581009, MINNEAPOLIS, MN, 55458-1009, US

(21) Appl. No.: 10/543,571

(22) PCT Filed: Feb. 25, 2004
(86) PCT No.: PCT/IB04/50152

§ 371 Date: May 16, 2006

(30) Foreign Application Priority Data
Feb. 26, 2003 (IT) RM2003A000083

(51) Int. Cl. G02C 5/00

(52) U.S. Cl. 351/41

(57) ABSTRACT

A glasses (100) frame (; 11), comprising a core (2) exhibiting an elastic deformability such as to allow the easy wearing on of the glasses by a user and an outer coating (3; 30) coupled to the core (2) allowing the resulting temple to preserve the elastic deformability properties of the core itself.

### DESCRIPTION

The present invention refers to a glasses frame and to a related pair of glasses. It is a common experience that the choice of a pair of glasses is carried out reaching a compromise between two different needs: the first is that of finding a frame having an aesthetical aspect which meets personal taste, the second is that the frame itself is easily worn on and fits as best as possible individual physiognomy. Therefore, often in the choice of a pair of glasses compromises are due: perhaps a nice, yet imperfectly fitting design, or, on the contrary, a highly comfortable, yet not aesthetically appreciated design is found.

The present invention stems from the finding that the easy wearing on of a glass substantially depends on the elastic deformability of its frame, and in particular of the temples thereof. However, often the materials exhibiting a suitable elastic deformability are not pleasant-looking, or anyhow allow a limited range of possible aesthetic effects and, vice-versa, the materials which would give a pleasant look to the glasses or implement a wide range of aesthetic effects do not exhibit the desirable elastic deformability.

Therefore, the technical problem underlying the present invention is to provide a glasses frame and a related pair of glasses overcoming the drawbacks hereto mentioned with reference to the known art.

This problem is solved by a glasses frame according to claim 1.

The present invention further provides glasses according to claim 16.

According to the same inventive concept, the invention further refers to a method for making a glasses frame according to claim 17.

Preferred features of the present invention are provided for in the dependent claims thereof.

It will be understood that the term ‘glasses’ should be construed in its broadest meaning, as comprising any kind of glasses, and in particular sunglasses and reading glasses.

The present invention entails several relevant advantages. The main advantage lies in that the glasses frame according to the invention, by virtue of its composite structure, allows the easy wearing on of the glasses as well as the possibility of attaining any valuable aesthetical aspect thereof. In fact, the elastically deformable inner core provides the required degree of adjustability of the glasses to the physiognomy of the individual, whereas the outer coating, it being unconstrained by said elasticity requirement, may have any aspect or implement any aesthetic effect.

Hence, the invention actually makes the aesthetical aspect and the ergonomic aspect of a glasses independent therebetween, as it enables to choose the best-liked frame with the certainty of having it also easily worn on.

Other advantages, features and the modes of employ of the present invention will be made apparent in the following detailed description of some embodiments thereof, given by way of a non-limiting example. Reference will be made to the figures of the attached drawings, wherein:

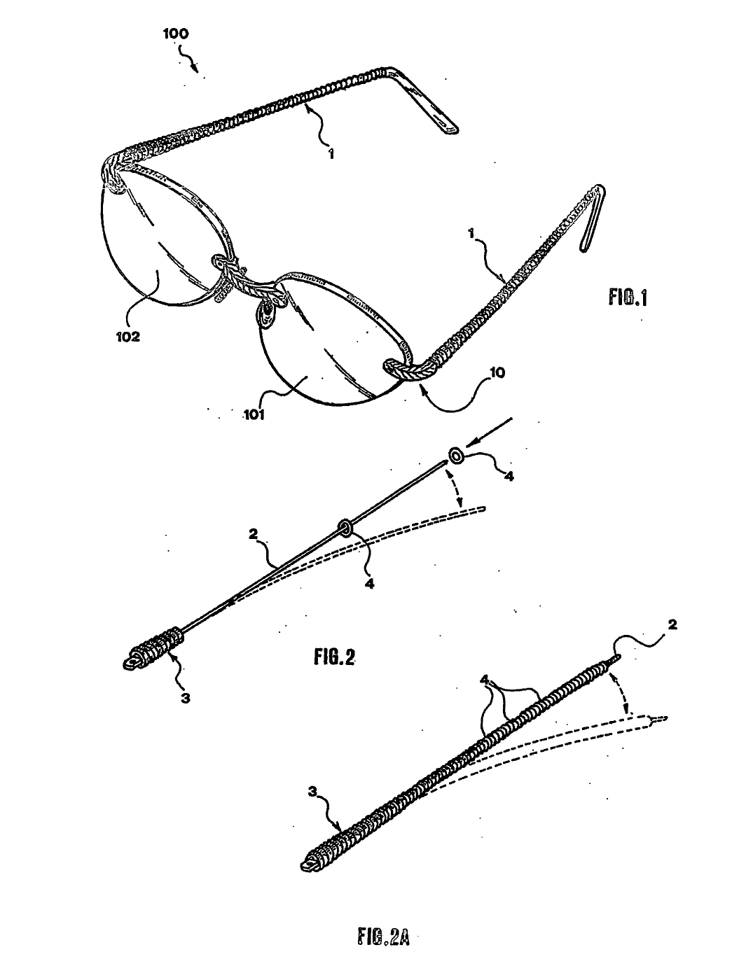

FIG. 1 is a perspective view of a first embodiment of glasses according to the present invention;

FIGS. 2A and 2B show each a respective step of making the glasses of FIG. 1, being each a perspective view of a temple thereof;

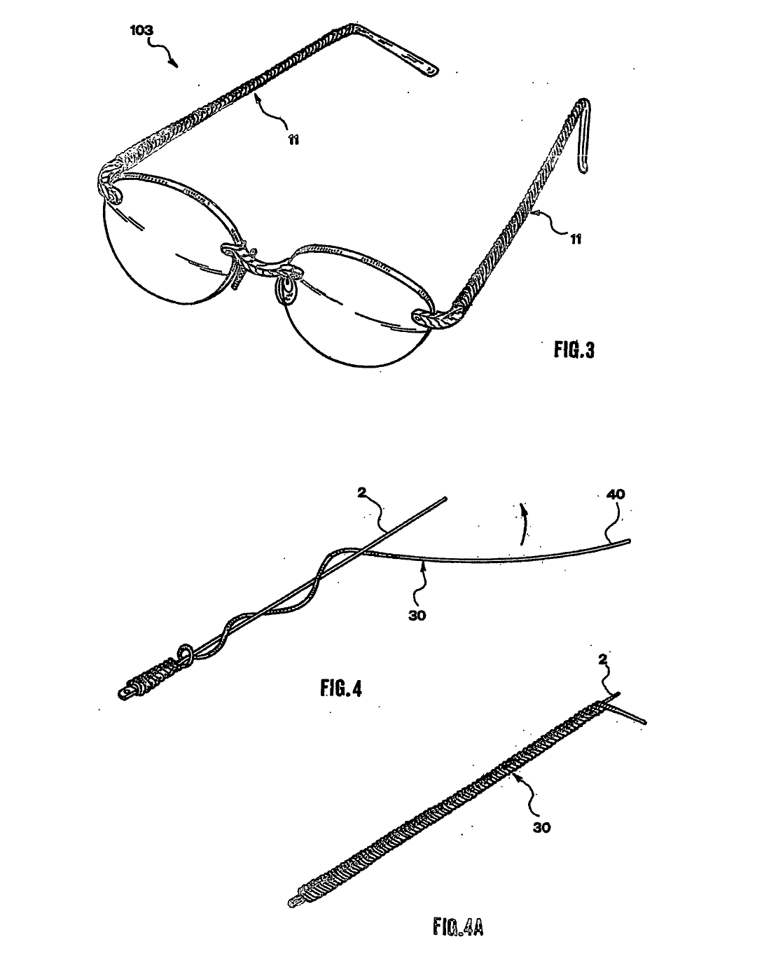

FIG. 3 is a perspective view of a second embodiment of glasses according to the present invention; and

FIGS. 4A and 4B show each a respective step of making the glasses of FIG. 2, being each a perspective view of a temple thereof.

With initial reference to FIG. 1, a pair of glasses according to a first embodiment of the present invention is generally indicated by 100. The glasses 100 comprise, alike any known-art glasses, a frame 10 and a pair of lenses, 101 and 102 respectively, supported by the frame 10 itself.

The frame 10 in turn comprises a first and a second wear-on temple, each indicated by 1. According to the invention, each of the two temples 1 has a composite structure, as indicated in greater detail in FIGS. 2A and 2B, referring each to a respective step of the method of making one of the temples 1.

In particular, each temple 1 comprises an inner core 2 made of an elastically deformable material, and specifically such as to allow an easy wearing on of the glass by a user.

In the present embodiment the core 2 is made of Titanium.

Variant embodiments could of course envisage alternative materials for the making of such a core, like e.g., stainless steel, shape memory alloys, and so on.

Moreover, each temple 1 comprises an outer coating 3 of the core 2, which in the present embodiment is made of a precious metal, like e.g. gold, apt to give a pleasant aspect to the glasses 100.

According to the invention, the coating 3 is coupled to the core 2 so that the resulting temple 1 preserves the elastic deformability properties of the core 2 itself, i.e. so that the temple 1 may be elastically deformed at the wearing on by a user.

Therefore, such a coupling allows the coating 3 to exhibit also a rigidity substantially greater with respect to the core 2 itself.

In the present embodiment, the coating 3 has a structure with rings 4, said rings 4 being threaded on the core 2 so as to be side by side to each other. It will be understood that said coupling leaves defined a certain degree of translational and rotational mobility between core 2 and coating 3, allowing the temple 1 overall to preserve taste emetic deformability properties of its idler core 2.

One or more of said ring elements 4 could also be made of a centrally pierced precious or semiprecious stone.

In an alternative embodiment shown in FIGS. 3, 4A and 4B, a frame according to the invention, in this case indicated by 103, comprises a temple, in this case indicated by 11, in turn formed by a core analogous to the hereto-described one and therefore indicated in this case as well by 2, and by a coating, in this case indicated by 30, obtained by winding a foil 40 of precious metal substantially helically about the core 2. The ends of the foil 40 may be fixed to the temple I 1 according to. conventional techniques.

It will be understood that also this second type of coupling leaves defined a certain degree of movability, in this case mainly rotational, between core 2 and coating 30, allowing the temple 11 overall to preserve the elastic deformability properties of its inner core 2.

It will be understood that the present invention is susceptible of several embodiments alternative to the hereto-described ones, some of which will briefly be illustrated hereinafter with reference to the sole aspects differentiating them from what has been illustrated hereto.

First of all, the invention generally refers to a glasses frame comprising a portion having a core-coating composite structure as described hereto with regard to the temples of the frame itself. Therefore, such a composite structure may be used, besides from or alternatively to the making of one or both of the temples of the frame, also for the making of the other elements of the latter, like in particular the two side elements coupling the temples to the lens seats, and the central element of the frame, or bow, separating the lenses themselves. Of course, which portion or portions of the frame are made with said composite structure depends on the specific elastic deformability properties that are to be given to the frame itself.

Moreover, the core-coating coupling may be made according to modes alternative to the hereto-described ones, by relying on any type of sliding and/or rotary coupling between said components.

For instance, in an alternative embodiment the coating may consist of a tubular structure opened longitudinally at a slit that is indeed longitudinal. Such an opened tubular coating may be obtained by forming a foil that is folded on itself. The presence of this opened slit allows a certain elastic deformation, both by torsion and by flexure, to the coating. Thus, once one or more tubules are threaded on the core, they can be guided by the elastic properties of the core itself.

Moreover, according to the specific embodiment, the geometric shape and the aesthetic features of the temple of the invention may vary greatly, and on this there may also be applied ornaments of any type whatsoever, e.g. set stones of various kinds and sizes.

Lastly, the materials with which the core and the related coating are made may be the most varied, e.g. precious and non-precious metals, plastic materials, resins, bone, wood, and so on, always with said respective elastic deformability properties.

It will be understood that the present invention refers both to a glasses frame and to a pair of glasses comprising such a frame.

The invention further provides a method for making a glasses frame, envisaging the following main steps:
providing a core as defined above;
providing a coating of said core, it also according to what has been described hereto with reference to the hereto-disclosed embodiments; and
coupling the coating to the core, so that the resulting frame preserves the elastic deformability properties of the core itself, wherein also this latter step may provide the hereto-described coupling modes.

The present invention was hereto described with reference to preferred embodiments thereof. It is understood that there may be other embodiments, afferent to the same inventive kernel, all falling within the protective scope of the claims hereinafter.

1. A glasses frame having, at at least one portion thereof, a composite structure comprising:
a core shaving an elastic deformability such that to allow an easy wearing on of the glasses by a user; and
an outer coating of said core,
wherein said coating coupled to said core in such a way that the resulting structure preserves the elastic deformability properties of said core so that it can be elastically deformed at the wearing on by the user,
wherein said outer coating has a structure with rings, said rings being inserted on said core,
and wherein said outer coating is slidably and rotatably coupled to said core.

2-10. (canceled)

11. Glasses, comprising a frame according to claim 1.

12. A method for making a glasses frame, comprising the steps of:
providing a core having an elastic deformability such as to allow an easy wearing on of the glasses by a user;
providing an outer coating of said core; and
coupling said coating to said core so as to obtain a composite structure that preserves the elastic deformability properties of said core so that it can be elastically deformed at the wearing on by the user, said composite structure being used to make at least one portion of the frame itself,
wherein said outer coating has a structure with rings, said step of coupling providing that said rings be inserted on said core,
and wherein said step of coupling provides the attainment of a sliding and rotary coupling of said coating to said cores.

13-21. (canceled)

22. The frame according to claim 1, wherein said coating has a rigidity substantially greater with respect to said core.

23. The frame according to claim 1, wherein said coating is made of precious metal.

24. The frame according to the claim 23, wherein said coating is made of gold.

25. The frame according to claim 1, wherein said core is made of a material comprising titanium.

26. The frame according to claim 1, wherein said core is made of a material comprising stainless steel.

27. The frame according to claim 1, wherein said core is made of a material comprising a shape memory alloy.

28. The frame according to claim 1, wherein said portion having said composite structure comprises at least one temple of the frame itself.

29. The frame according to claim 1, wherein said portion having said composite structure comprises at least one side element coupling a temple of the frame itself to the adjacent lens seat thereof.

30. The frame according to claim 1, wherein said portion having said composite structure comprises the central bow of the frame itself.

31. The method according to claim 12, wherein said outer coating of said core exhibits a rigidity substantially greater with respect to the core itself.

32. The method according to claim 12, wherein said coating is made of precious metal.

33. The method according to claim 32, wherein said coating is made of gold.

34. The method according to claim 12, wherein said core is made of titanium.

35. The method according to claim 12, wherein said core is made of a material comprising stainless steel.

36. The method according to claim 12, wherein said core is made of a material comprising a shape memory alloy.

37. The method according to claim 12, wherein said composite structure is used to make at least one temple of the frame.

38. The method according to claim 12, wherein said composite structure is used to make at least one side element coupling a temple of the frame itself to the adjacent lens seat thereof.

39. The method according to claim 12, wherein said composite structure is used to make the central bow of the frame itself.
